(19) United States
(12) Patent Application Publication
(10) Pub. No.: US 2004/0045956 A1
(43) Pub. Date: Mar. 11, 2004

(54) Heating element with stranded contact

(76) Inventor: Michael Weiss, Benedictbeuren (DE)

Correspondence Address: ARTZ & ARTZ, P.C., 28333 TELEGRAPH RD., SUITE 250, SOUTHFIELD, MI, 48034, US

(21) Appl. No.: 10/415,798

(22) PCT Filed: Aug. 28, 2002
(86) PCT No.: PCT/DE02/03185

(30) Foreign Application Priority Data
Sep. 3, 2001 (DE) 10142878.2

(51) Int. Cl. H05B 3/08

(52) U.S. Cl. 219/541

(57) ABSTRACT

The invention relates to a heating element (1) with a flat heater resistor (2) and at least two contact regions (4, 4′) that are arranged a distance apart from one another on the heater resistor (2).

Provision is made for at least one of the contact regions (4, 4′) to have a stranded wire (6, 6′), which stands in electrically conductive connection with the heater resistor (2) over a relatively great distance (8), has a plurality of filament wires, and is loosely twisted at most.

The present invention relates to a heating element in accordance with the preamble to claim 1. Generic heating elements are used to heat surfaces of useful items standing in contact with a user.

### PRIOR ART

It is known to contact electrically conductive textiles with sewn-on electrodes.

However, this process is very cost-intensive under certain circumstances.

It is also known to use metallic or metallized adhesive tapes as electrodes for flat heater resistors. However, problems arise here regarding the durability of the adhesive connection and ensuring adequate passage of current from the electrode to the flat heater resistor.

Riveted connections are also known. However, these represent a source of mechanical problems. Moreover, they only provide a point electrical contact.

### SUBJECT MATTER OF THE INVENTION

A heating element in accordance with claim 1 permits the introduction of current from an electrode to a flat heater resistor over a large area. In addition, it is easy to automate production of such a connection, and thus economical. Moreover, such an electrode is also capable of withstanding continuous mechanical stress.

A heating element in accordance with claim 2 is characterized by a good conductive connection between an electrode and a flat heater resistor.

A heating element in accordance with claim 3 permits distribution of the supplied current over the entire available width or length of the heating element.

A heating element in accordance with claim 4 has a great number of current-carrying filament wires and hence a large contact surface between electrode and flat heater resistor.

A heating element in accordance with claim 5 has a relatively large diameter of the filament wires in comparison to conventional stranded wires. As a result, the resistance of the individual wires is reduced.

A heating element in accordance with claim 6 permits an increase in the amount of current that can be supplied without excessively increasing the material costs.

A heating element in accordance with claim 7 permits conformation of the stranded wire to the heating element over a large area, due to twisting of the filament wires that is loose at most. The transition resistance is significantly reduced in this way.

A heating element in accordance with claim 8 likewise produces a reduction in transition resistance.

### FIGURES

The following description discusses possibilities for implementing the invention. These remarks should be viewed as examples only, and are made with reference to:

FIG. 1 top view of a heating element in accordance with the invention.

### DESCRIPTION OF THE INVENTION

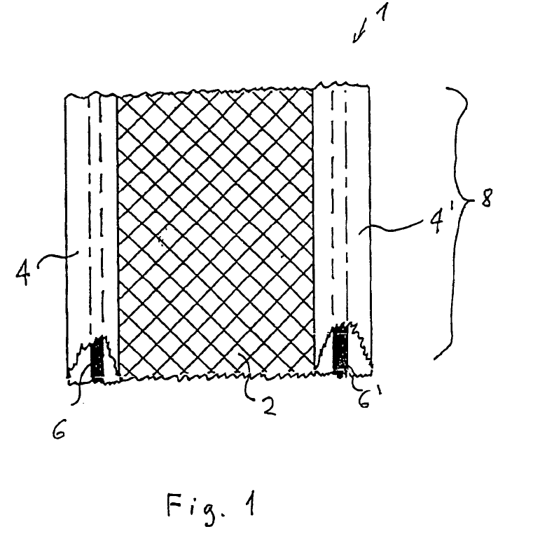

FIG. 1 shows a top view of a section of a heating element 1 in accordance with the invention. The heating element 1 has a flat, bandlike heater resistor 2. Provided on the longitudinal sides of the heater resistor 2 are contact regions (4, 4′). In each case, the contact regions (4, 4′) are formed by folding over the longitudinal edges of the heater resistor 2. In this way, each contact region (4, 4′) takes the shape of a tubular pocket.

One stranded wire (6, 6′) is provided in each of the tubular pockets of the contact regions (4, 4′). The stranded wire (6, 6′) has a relatively large number of filament wires, preferably between 40 and 110 filament wires per stranded wire. In the present example embodiment, there are 80.

The filament wires have a diameter from 10-100 μm, in the present example embodiment 50 μm.

The stranded wire is twisted only loosely. The number of turns is preferably from 0 to 10, and in the present example embodiment there is one turn of the stranded wire per meter.

The filament wires are provided with a silver coating to increase their conductivity. This allows easier current transmission from the stranded wire (6, 6′) to the heater resistor 2.

The stranded wire (6, 6′) runs lengthwise along the entire length of the heater resistor 2. This permits current to be supplied to the heater resistor 2 over the entire length of the heating element 1. In this way, very wide or long heating elements can be realized.

The stranded wire (6, 6′) can simply be inserted in the tubular pocket in the contact region (4, 4′). However, it can also be additionally attached, for example through sewing, gluing or riveting.

The tubular pocket in the contact region can also be formed by additionally applied strips of material, for example adhesive or hook-and-loop strips, instead of by the material of the resistance element 2. It would also be possible to omit a tubular embodiment of the contact regions. The stranded wire could also be applied to the resistance element uncovered on one side.

Instead of a single stranded wire, two stranded wires could also be laid next to each other in each contact region. The amount of current that can be supplied could be increased easily in this way. While a larger number of stranded wires is also conceivable, it is less desirable because of additional material costs.

1. Heating element (1) with a flat heater resistor (2) and at least two contact regions (4, 4′) that are arranged a distance apart from one another on the heater resistor (2), characterized in that at least one of the contact regions (4, 4′) has a stranded wire (6, 6′) which stands in electrically conductive connection with the heater resistor (2) over a relatively great distance (8), has a plurality of filament wires, and is loosely twisted at most.

2. Heating element in accordance with claim 1, characterized in that the distance (8) over which the stranded wire (6, 6′) is in contact with the heater resistor (2) is greater than 2 cm, preferably greater than 10 cm.

3. Heating element in accordance with one of the preceding claims, characterized in that the stranded wire (6, 6′) stands in electrically conductive connection with the heater resistor (2) over essentially all of a direction of extension of the heater resistor (2).

4. Heating element in accordance with one of the preceding claims, characterized in that the number of filament wires is at least 40, preferably between 60 and 120, preferably between 80 and 110.

5. Heating element in accordance with one of the preceding claims, characterized in that the diameter of the filament wire is between 10 and 100 μm, preferably between 40 and 60 μm.

6. Heating element in accordance with one of the preceding claims, characterized in that two stranded wires (6, 6′) are provided instead of a single stranded wire (6, 6′).

7. Heating element in accordance with one of the preceding claims, characterized in that the stranded wire (6, 6′) has a maximum of 10 turns per meter for twisting of the filament wires about its longitudinal axis, preferably a maximum of 5 turns per meter, preferably a maximum of 1 turn per meter.

8. Heating element in accordance with one of the preceding claims, characterized in that the filament wires and/or the stranded wires (6, 6′) have a silver coating.
